(19) United States
(12) Patent Application Publication
(10) Pub. No.: US 2025/0285202 A1
(43) Pub. Date: Sep. 11, 2025

(54) SECURE COMMUNICATIONS SYSTEM FOR DUE PROCESS

(71) Applicant: LIGHTNING DEP INC. d/b/a Lightning Law, Carefree, AZ (US)

(72) Inventor: Alisa R. BRODKOWITZ, Carefree, AZ (US)

(21) Appl. No.: 18/600,276

(22) Filed: Mar. 8, 2024

(51) Int. Cl. G06Q 50/26; G06Q 50/18; H04L 9/40; H04L 12/18; H04L 51/046; H04L 51/216

(52) U.S. Cl. CPC G06Q 50/26; G06Q 50/18; H04L 12/1818; H04L 12/1831; H04L 51/046; H04L 51/216

(57) ABSTRACT

The technology disclosed herein relates to methods, media, and systems for secure communications (e.g., a video conference) for a confined individual (e.g., via imprisonment, confinement to a mental institution by a lawful authority, detained as a suspected criminal, etc.). In embodiments, a secure communications system can provide one or more identifiers for a confined individual to a correctional facility system for scheduling secure electronic communications (e.g., a video conference) between the confined individual and legal counsel or another entity associated with a legal proceeding for the confined individual. Based on receiving, by the secure communications system and from the correctional facility system, a confirmation, a secure communications session can be scheduled for the confined individual. A client device or particular account for the confined individual can be restricted from viewing messages and electronic document modifications upon completion of the secure communication session.

### BACKGROUND

Mail is one of the most persistent channels for smuggling drugs or contraband to inmates in correctional facilities. For example, prisons have experienced a 600% rise in drug overdoses among inmates over the past several years due to the smuggling of fentanyl and other contraband through the mail service. Fentanyl poses a significant risk to the health and safety of both inmates and prison employees. Many prison systems have either tried or fully implemented procedures for photocopying or digitally scanning physical mail addressed to incarcerated recipients. These procedures can violate prisoners' First Amendment rights and privacy rights. In addition, these procedures can also violate people's rights to communicate freely and confidentially with their attorneys by forcing the scanning of legal mail into scanners or photocopiers.

### SUMMARY

This summary provides a high-level overview of various aspects of the technology disclosed herein, and the detailed-description section below provides further description herein. This summary is not intended to identify key features or essential features of the claimed subject matter, nor is it intended to be used as an aid in isolation to determine the scope of the claimed subject matter. The present disclosure is directed, in part, to technology associated with improved computer-implements tools, methods, systems, and media for providing secure communications via a secure communications system for a confined individual (e.g., an individual who is confined via imprisonment, confined to a mental institution by a lawful authority, detained as a suspected criminal, etc.), substantially as shown in and/or described in connection with at least one of the figures, and as set forth more completely in the claims.

For example, embodiments discussed herein include methods, media, and systems that provide for secure communications for a confined individual (e.g., between the confined individual and an attorney who is representing or potentially representing the confined individual, between the confined individual and an interpreter, between the confined individual and one or more parole board members, etc.).

In embodiments, one or more identifiers for the confined individual can be provided by a secure communications system to a correctional facility system. For example, the one or more identifiers for the confined individual may include one or more of an image (e.g., a digital image) of the confined individual (e.g., a state ID, driver's license, commercial driver's license, a government issued ID, etc.), a birth certificate (e.g., a scanned or digital birth certificate), a social security card (e.g., a digital social security card), a social security number, an alphanumeric identifier (e.g., a unique inmate number, such as a DOC number, prisoner ID number, a BOP federal number, etc.), another type of identifier for the confined individual, or one or more combinations thereof.

Additionally, one or more legal counsel identifiers for legal counsel can be provided by the secure communications system to the correctional facility system. For example, the one or more legal counsel identifiers may include one or more of a bar license number, court admission documents, other certifications, an image identifier of the attorney, legal documents or agreements associated with the confined individual, a driver's license, a passport, another type of government issued ID, another type of legal counsel identifier, or one or more combinations thereof.

In some embodiments, based on receiving, from the correctional facility system, a confirmation associated with the one or more identifiers for the confined individual, the secure communications system can schedule an audio or video conference for the confined individual. In some embodiments, the video conference may encompass a virtual reality, augmented reality, extended reality, etc., court appearance for a confined individual.

In some embodiments, the video conference can be scheduled between the confined individual and one or more of the legal counsel (e.g., an attorney who is representing or potentially representing the confined individual), an interpreter, one or more parole board members, another entity associated with a legal proceeding for the confined individual, or one or more combinations thereof. The scheduled video conference can have an associated time, date, duration, and identifiers for the participants (e.g., email address, phone number, names, etc.). In embodiments, based on scheduling the video conference, the secure communications system can transmit, to the correctional facility system, a notification of the video conference (e.g., the notification including the associated time, date, duration, participant identifiers, etc., or one or more combinations thereof). For instance, the notification to the correctional facility system can be used by the correctional facility system to arrange for providing a client device (e.g., a tablet) to the confined individual during the time and date of the scheduled video conference for the duration of the video conference.

During the video conference, the confined individual or another participant may provide annotations (e.g., comments) or other modifications to various electronic legal documents shared during the video conference. By way of example, an electronic legal document may include a complaint, an indictment, a pleading, evidence, a summons, or another type of legal document, and the legal counsel participating in the video conference may modify the document using comments and highlighting. As another example, messages can be exchanged between or among participants of the video conference via one or more messaging thread interfaces. Upon completion of the video conference, the confined individual can be restricted from having access to any of the modifications or exchanged messages during the video conference.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

Implementations of the present disclosure are described in detail below with reference to the attached drawing figures, wherein:

FIG. 1 depicts an example operating environment for the secure communications system for conferences between a confined individual and an entity associated with a legal proceeding for the confined individual, in accordance with embodiments herein;

FIGS. 2-18 illustrate examples of secure communications system interfaces generated by the secure communications system, in accordance with embodiments herein;

FIG. 19 illustrates an example flowchart for utilizing the secure communications system, in accordance with embodiments herein; and

FIG. 20 depicts an example client device suitable for use in implementations of the present disclosure, in accordance with embodiments herein.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies.

### Terms

Although the terms “step” and/or “block” may be used herein to connote different elements of methods employed, the terms should not be interpreted as implying any particular order among or between various steps herein disclosed unless and except when the order of individual steps is explicitly described.

In addition, words such as “a” and “an,” unless otherwise indicated to the contrary, may also include the plural as well as the singular. Thus, for example, the constraint of “a feature” is satisfied where one or more features are present.

Furthermore, the term “or” includes the conjunctive, the disjunctive, and both (a or b thus includes either a or b, as well as a and b).

“Computer storage media” does not comprise signals per se.

Unless specifically stated otherwise, descriptors such as “first,” “second,” and “third,” for example, are used herein without imputing or otherwise indicating any meaning of priority, physical order, arrangement in a list, or ordering in any way, but are merely used as labels to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

Further, the term “some” may refer to “one or more.” Additionally, an element in the singular may refer to “one or more.” The term “plurality” may refer to “more than one.”

The term “combination” (e.g., one or more combinations thereof) may refer to, for example, “at least one of A, B, or C”; “at least one of A, B, and C”; “at least two of A, B, or C” (e.g., AA, AB, AC, BB, BA, BC, CC, CA, CB); “each of A, B, and C”; and may include multiples of A, multiples of B, or multiples of C (e.g., CCABB, ACBB, ABB, etc.). Other combinations may include more or less than three options associated with the A, B, and C examples.

As used herein, the phrase “based on” shall be construed as a reference to an open set of conditions. For example, an example step that is described as “based on X” may be based on both X and additional conditions, without departing from the scope of the present disclosure. In other words, as used herein, the phrase “based on” shall be construed in the same manner as the phrase “based at least in part on.”

Additionally, a “client device” or “legal counsel device,” as used herein, is a device that has the capability of transmitting or receiving one or more signals to or from a network node, and may also be referred to as a “computing device,” “mobile device,” “user equipment,” “user device,” etc. A “client device” or “legal counsel device,” in some embodiments, may take on a variety of forms, such as a PC, a laptop computer, a tablet, an IoT device, a wearable device, a mobile phone, a personal digital assistant, a server, another type of device that is capable of communicating with other devices (e.g., by transmitting or receiving a signal), or one or more combinations thereof.

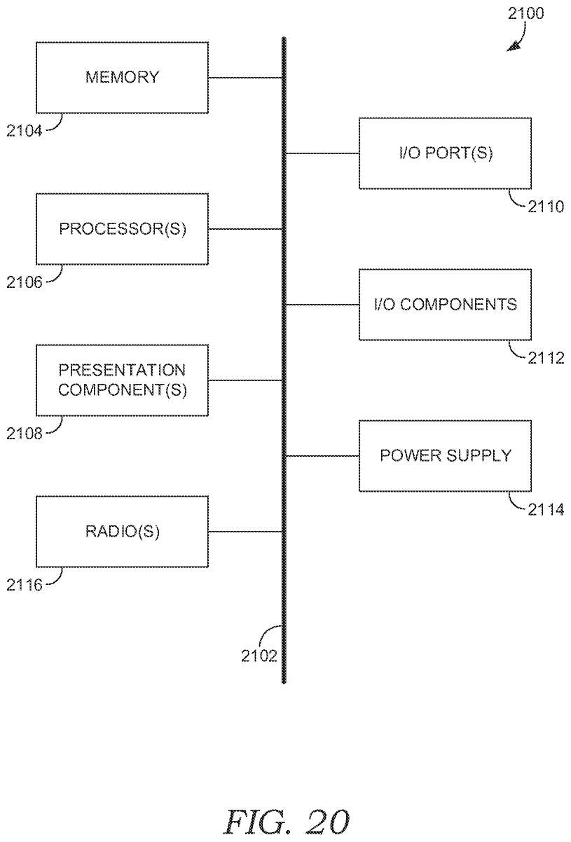

By way of example, in some example embodiments, the “client device” may be a tablet and the “legal counsel device” may be a laptop computer. In some embodiments of the client device for the confined individual, the correctional facility may implement particular restrictions (e.g., Wi-Fi restrictions such as particular webpages or websites, access to Wi-Fi only without access to wireless telecommunication services provided via a telecommunications provider) for one or more client devices (e.g., tablets) provided to the confined individual during particular time periods. A “client device” or “legal counsel device,” in some embodiments, may be client device 2100 described herein with respect to FIG. 20.

A “correctional facility” as used herein can refer to a jail, prison, or other detention facility used to house people who have been arrested, detained, held, or convicted by a criminal justice agency or a court.

A “confined individual” can be an individual who is being held, detained, or incarcerated in a correctional facility. In some example embodiments of a “confined individual,” a confined individual can be someone who manifests obvious signs of a mental illness or has been diagnosed by a qualified mental health professional as having a mental illness.

A “legal proceeding” for the confined individual can correspond to a proceeding associated with an investigation, trial, sentencing, parole interviews, etc.

As used herein, “jurisdiction” may refer to particular legal rules or legal regulations being applied based on the appropriate regulatory authority. For example, a particular state court or federal court may have jurisdiction depending on the circumstances or types of criminal acts. In some embodiments, “jurisdiction” can include personal jurisdiction, subject matter jurisdiction, or both.

The term “attorney-client privilege” includes protected, confidential communications between an attorney and a client (or potential client) relating to legal advice or legal services for the client (e.g., related to a criminal legal proceeding). The term “attorney-client privilege” protection may extend to any format of information exchanged during a privileged communication, such as a verbal communication, a written correspondence, an email, a text message, or another form of conveying the privileged information.

Embodiments of the technology described herein may be embodied as, among other things, a method, system, or computer-program product. Accordingly, the embodiments may take the form of a hardware embodiment, or an embodiment combining software and hardware. An embodiment that takes the form of a computer-program product can include computer-useable instructions embodied on one or more computer-readable media.

Computer-readable media include both volatile and nonvolatile media, removable and non-removable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal (e.g., a modulated data signal referring to a propagated signal that has one or more of its characteristics set or changed to encode information in the signal). Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

### Overview

By way of background, correctional facilities have encountered issues with physical mail for inmates, such as the smuggling of drugs and contraband, as well as issues with digital mail, such as violations of prisoners' constitutional rights and privacy rights. For example, computing devices and digital platforms used by inmates within correctional facilities have also failed to secure communications between inmates and their families. As an example, a prison video visitation provider has encountered security lapses that exposed thousands of phone calls that should have been private or confidential. During this security lapse, one of the databases of the prison video visitation provider exposed to the internet each of the inmates' call logs and transcriptions of those calls. Those transcriptions also publicly provided the phone number of the caller communicating with the inmate and the duration of the call. Furthermore, correctional facilities have also encountered issues with inmates using digital platforms on the tablets to communicate with other inmates for committing additional criminal acts, such as conspiring to harm another inmate or smuggling contraband by physically handing the tablet to another inmate to read hidden messages within the tablet.

The present technology discussed herein provides for various improvements over prior technologies associated with mail delivery (e.g., electronic mail) to/from inmates and communications between inmates that involve drugs, contraband, or other criminal or impermissible acts. For example, a secure communications system disclosed herein can enhance the security of communications between a confined individual and another entity corresponding to a legal proceeding for the confined individual (e.g., legal counsel) so that private or privileged communications (e.g., attorney-client privileged) cannot be publicly exposed. As another example, the secure communications system disclosed herein can enhance the security of various databases including private or privileged data. Furthermore, the secure communications system disclosed herein can generate and provide enhanced security computing features and functionality so that inmates cannot illegally or impermissibly exchange particular data using computing devices issued to the confined individuals within a correctional facility.

In an example embodiment, a secure communications system is provided. The secure communications system comprises one or more processors and computer memory storing computer-usable instructions that, when executed by the one or more processors, cause the system to perform operations. The operations may comprise providing one or more legal counsel identifiers and one or more identifiers for a confined individual to a correctional facility system. The operations may further comprise receiving, from the correctional system, a confirmation associated with the one or more legal counsel identifiers and the one or more identifiers for the confined individual. Based on receiving the confirmation, a video conference can be scheduled for the confined individual. In some embodiments, the video conference is initiated between a counsel device associated with the one or more counsel identifiers and a client device associated with the one or more identifiers for the confined individual. In some embodiments, the video conference includes a virtual reality, extended reality, augmented reality, etc., court appearance.

As one non-limiting example, the video conference can be initiated based on comparing facial features of the confined individual from a camera of the client device with the one or more identifiers for the confined individual including a photo identifier of the confined individual. As another non-limiting example, the video conference can be initiated based on receiving log-in credentials (e.g., including biometrics, such as a thumbprint) for the confined individual on the client device. In addition, during the video conference, one or more electronic legal documents can be modified (e.g., annotated, signed, filled in) by the client device of the confined individual or the legal counsel device of legal counsel. For example, when the confined individual signs an electronic document during the video conference, the signature disappears for them (for instance, such that it is only visible to their attorney, until their attorney reviews it and provides a confirmation). In this way, confined individuals cannot use an open field in the software to communicate with other incarcerated people (e.g., if someone else was able to log on with their own credentials).

Additionally or alternatively, during the video conference, a messaging thread interface can be used for message exchanges between the client device of the confined individual and the legal counsel device. Upon completion of the video conference, the secure communications system can remove access to the modified electronic legal document, or remove access to the messages exchanged via the messaging thread interface, so that the modifications to the electronic legal document and the messages of the messaging thread interface cannot be accessible to the confined individual after the video conference.

In another embodiment, a method is provided. The method may include providing one or more legal counsel identifiers and one or more identifiers for a confined individual to a correctional facility system. The method may also include receiving, from the correctional facility system, a confirmation associated with the one or more legal counsel identifiers and the one or more identifiers for the confined individual. The method may also include transmitting a request to the correctional facility system, based on the confirmation, to schedule a parole interview video conference for the confined individual. Based on transmitting the request, the method may also include scheduling the parole interview video conference for the confined individual. Further, the method may also include initiating the parole interview video conference between at least one client device corresponding to at least one parole board member and a client device corresponding to the confined individual, wherein the parole interview video conference is initiated based on the one or more identifiers for the confined individual and one or more identifiers for the at least one parole board member.

### Technological Operational Environment

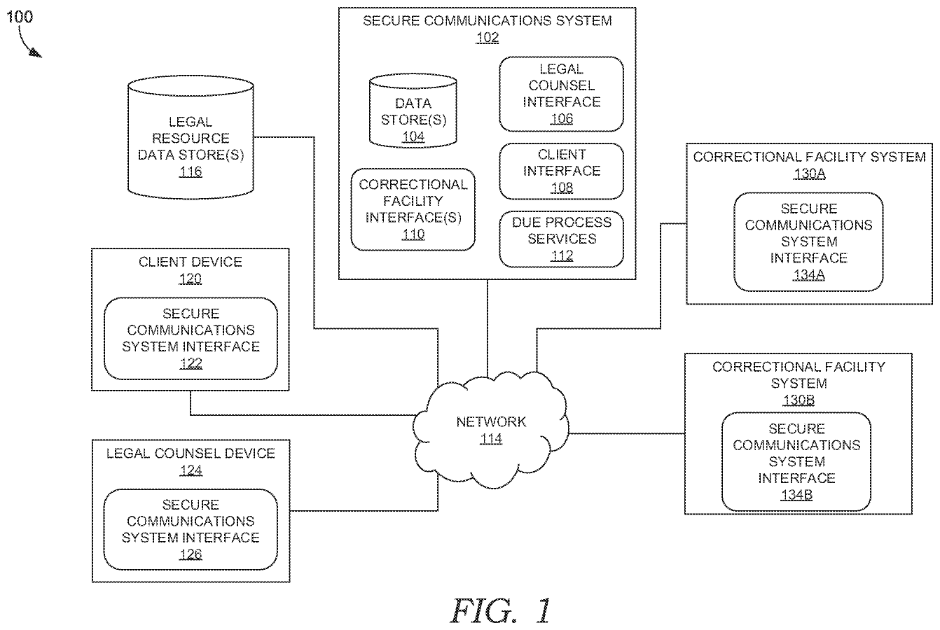

FIG. 1 depicts an example operating environment 100 that includes a secure communications system 102 comprising one or more data stores 104, legal counsel interface 106, client interface 108, correctional facility interface(s) 110, and due process services 112. The secure communications system 102 can communicate (e.g., via network 114) with one or more legal resource data stores 116, client device 120 (e.g., via secure communications system interface 122), legal counsel device 124 (e.g., via secure communications system interface 126), correctional facility system 130A (e.g., via secure communications system interface 134A), and correctional facility system 130B (e.g., via secure communications system interface 134B).

Example operating environment 100 is but one example of a suitable environment for the technology and techniques disclosed herein, and is not intended to suggest any limitation as to the scope of use or functionality of the invention. Neither should the environment 100 be interpreted as having any dependency or requirement relating to any one or combination of components illustrated. As one example, although depicted as a single database component, data store(s) 104 of the secure communications system 102 may be embodied as one or more databases (e.g., a distributed computing environment encompassing multiple computing devices) or may be in the cloud. As another example, other embodiments of example environment 100 may include additional correctional facility systems, additional client devices for confined individuals, additional client devices for translators, additional client devices for parole board members, additional client devices for other entities associated with a particular legal proceeding for a confined individual, and additional legal counsel devices.

In some embodiments, the secure communications system 102 can communicate with other components within example operating environment 100 over the network 114 via one or more communication links (e.g., one or more wired or wireless communication links that include a wire, a router, a switch, a transmitter, a receiver, another type of communication link component, or one or more combinations thereof). For example, the secure communications system 102 can communicate with the legal counsel device 124 via secure communications system interface 126 and legal counsel interface 106. As another example, the secure communications system 102 can communicate with the client device 120 via client interface 108 and secure communications system interface 122 based on receiving a confirmation from the correctional facility system 130A (e.g., via the correctional facility interface(s) 110 and secure communications system interface 134A).

In embodiments, the network 114 may be a local area network, a wide area network, a mesh network, a public switched telephone network, a hybrid network, another wired or wireless networks, or one or more combinations thereof. Network 114 may be the Internet or another public or private network. As an example, the secure communications system 102 may provide secure video sessions and messaging thread interfaces for a client device 120 of a confined individual over the network 114 or a portion thereof.

For instance, the secure communications system 102 can provide the secure video sessions, secure audio sessions, secure messaging thread interfaces, etc., or one or more combinations thereof, based on receiving confirmation from the correctional facility in which the confined individual is located. To illustrate, if the confined individual is within a correctional facility associated with the correctional facility system 130A, the secure communications system 102 can facilitate the scheduling of a secure video session or a secure audio session with the confined individual in response to receiving a confirmation from that correctional facility. In embodiments, the confirmation can be received from the correctional facility system 130A electronically (e.g., via the secure communications system interface 134A). In other embodiments, the confirmation can be received from the correctional facility via a fax transmission or physical mail. For example, the physical mail or fax received can be uploaded to the secure communications system 102 and stored within the data store(s) 104.

In some embodiments, the confirmation can be received based on providing the correctional facility system 130A (e.g., via the correctional facility interface(s) 110 and the secure communications system interface 134A, via an entry into the secure communications system interface 134A) one or more identifiers of the confined individual (e.g., the confined individual's name, an image of the confined individual (e.g., a state ID, driver's license, commercial driver's license, a government issued ID, a mug shot, etc.), birth date, social security number, a unique inmate number, another type of identifier for the confined individual, or one or more combinations thereof). Additionally or alternatively, the confirmation can be received based on providing the correctional facility system 130A one or more legal counsel identifiers (e.g., for a public defender) for an attorney who is representing the confined individual (e.g., the legal counsel identifier including a bar license number, court admission documents, a driver's license of the attorney, a digital bar card for the attorney, legal documents or agreements associated with the confined individual, another type of legal counsel identifier, or one or more combinations thereof).

In some embodiments, the confirmation can be received based on a verification that the attorney is representing or offering to represent the confined individual. For example, the secure communications system 102 can provide the correctional facility system 130A verified legal documents or agreements associated with the confined individual and the attorney. As another example, the secure communications system 102 can utilize one or more blockchains to verify the one or more legal counsel identifiers. For instance, the secure communications system 102 may retrieve a particular legal counsel identifier stored on a private blockchain and verify the integrity of that particular legal counsel identifier without disclosure of particular private block chain entries (e.g., associated with attorney-client privileged data). As another example, the secure communications system 102 can transmit an authentication document hash for a particular legal counsel identifier to the correctional facility system 130A. In some embodiments, the correctional facility system 130A may upload physical mail including the particular legal counsel identifier or a copy thereof, and the uploaded document could be verified using the authentication document hash.

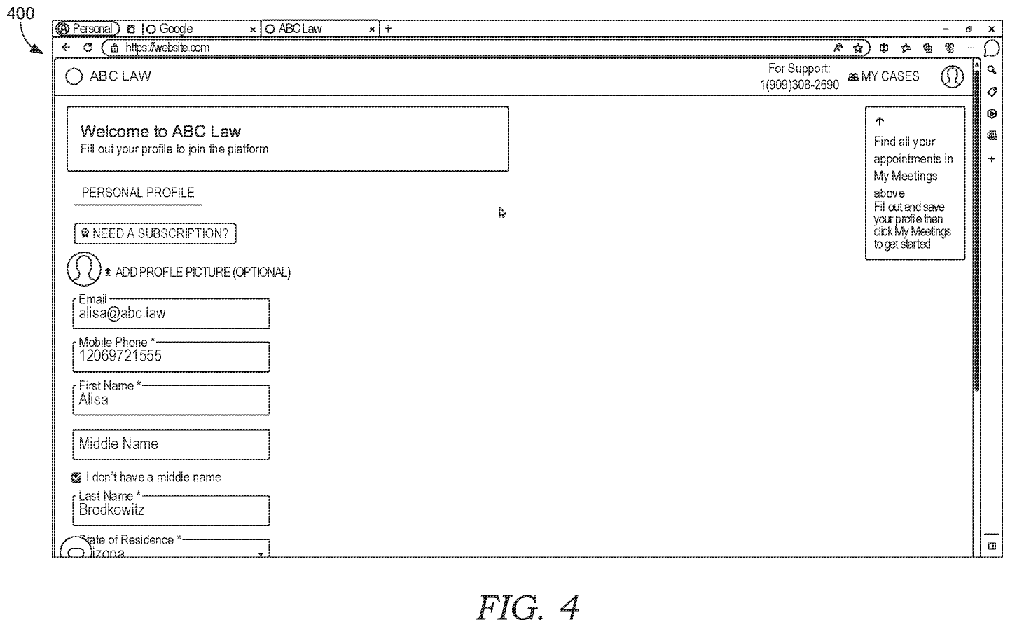

Based on receiving the confirmation from the correctional facility system 130A, a video conference or audio conference for the confined individual can be scheduled. For example, the video conference or audio conference can be scheduled for the confined individual and an entity associated with the legal proceeding for the confined individual. The scheduled meeting can have an associated time, date, and duration. In some embodiments, the meeting can be scheduled using a profile for the legal counsel (e.g., corresponding to the profile generation discussed with respect to FIG. 4). In embodiments, the secure communications system 102 may prevent screen sharing by the client device 120 that the confined individual is using. In some embodiments, the legal counsel device 124 can schedule the video or audio conference based on permission control features of the legal counsel device 124.

As another example, the secure communications system 102 may also add an interpreter to the video or audio conference for the confined individual. For example, the secure communications system 102 may add the interpreter to the scheduled meeting based on receiving, from the legal counsel device 124, an indication to include an interpreter for the video conference. In embodiments, the legal counsel device 124 can provide one or more interpreter identifiers for the interpreter. The one or more interpreter identifiers may include, for example, certification or credential data associated with a particular language and particular testing program, interpreter name, phone number, email or physical address, an active certified interpreter roster, other interpreter identifiers, or one or more combinations thereof. In some embodiments, the interpreter may be added to the video conference based on the secure communications system 102 utilizing one or more blockchains to verify the one or more interpreter identifiers.

In yet another example, the secure communications system 102 may schedule a parole interview video conference for the confined individual. The parole interview may include a question and answer session between the confined individual and one or more members of the parole board. For example, the interview is part of the parole process and helps the board determine whether or not to grant release of the confined individual and under what terms. In some embodiments, the secure communications system 102 can schedule the parole interview video conference based on one or more parole board member identifiers (e.g., email address, name, particular certificates, or other parole board member identifiers). As an example, the secure communications system 102 may schedule the video conference between the legal counsel and confined individual prior to the parole interview video conference for generating a parole plan (e.g., indicating a planned place to live upon grant of parole, indicating a potential place of employment upon grant of parole, etc.). Additionally, in some embodiments, the secure communications system 102 may schedule additional audio or video conferences for the confined individual after being released on parole.

In some embodiments, the secure communications system 102 can determine a parole eligibility date for the confined individual. The parole eligibility date may be based on a criminal history of the confined individual and the type of the criminal offense. For example, the secure communications system 102 may have various electronic legal documents stored within the data store(s) 104 for the confined individual, and the secure communications system 102 may extract the parole eligibility date from the data store(s) 104 (e.g., using one or more public and private decryption key pairs). In some embodiments, the secure communications system 102 may use one or more machine learning algorithms (e.g., a deep neural network, a convolutional neural network, a recurrent neural network, etc.) and natural language processing to determine the parole eligibility date for the confined individual. Based on determining the parole eligibility date for the confined individual, the secure communications system 102 can automatically transmit a request to the correctional facility system 130A for scheduling the parole interview video conference for the confined individual. In some embodiments, the secure communications system 102 may simultaneously transmit the request to the correctional facility system 130A and to an associated parole board system.

In some embodiments, the secure communications system 102 may initiate and provide the secure video sessions, audio sessions, and messaging thread interfaces based on receiving log-in credentials, such as biometrics, associated with one or more particular identifiers for the confined individual, based on receiving a cryptographic signature for the confined individual and the entity associated with the legal proceeding for the confined individual, based on a single-sign on (SSO) by the confined individual and the entity associated with the legal proceeding for the confined individual (e.g., based on a network access protocol, via a cloud-based SSO system, via a web-based SSO system, via an extended web-based SSO system that supports form-fill, etc.), based on a blockchain node invoking one or more smart contracts to verify the one or more legal counsel identifiers and the one or more identifiers for the confined individual, etc., or one or more combinations thereof.

In embodiments, the secure video sessions, audio sessions, and messaging thread interfaces may be established based on a private IP address for the client device 120 of the confined individual, a private IP address of a client device of another entity associated with a legal proceeding for the confined individual, and a gateway server corresponding to the secure communications system 102 for mediating one or more transmissions between the client device for the confined individual and the client device of the entity associated with the legal proceeding for the confined individual. As one example, the private IP address may be extracted (e.g., by the secure communications system 102, the gateway server associated with the secure communications system 102, another server associated with the secure communications system 102, etc.) based on homomorphic encryption. As another example, one or more identifiers associated with the confined individual (or one or more identifiers of an interpreter, for example) can be extracted based on homomorphic encryption for establishing the secure video sessions and messaging thread interfaces.

In some embodiments, the secure communications system 102 may provide secure video sessions or secure audio sessions (e.g., between the client device for the confined individual and the client device of the entity associated with the legal proceeding for the confined individual) based on one or more of a peer-to-peer video or audio connection via the due process services 112 or a point-to-point video or audio connection via the due process services 112 (e.g., and through the secure communications system interface 126 of the legal counsel device 124 and the secure communications system interface 122 of the client device 120). For example, in some embodiments, the legal counsel device 124 may act as a peer device in a peer-to-peer network or other distributed network. The secure communications system 102 may locate the scheduled conference in data store(s) 104 and confirm that the scheduled meeting time and date has arrived and that particular biometrics or private IP addresses, for example, are associated with the particular participants of the scheduled conference.

In some embodiments, the due process services 112 can implement permission control features (e.g., via the legal counsel interface 106) so that the legal counsel device 124 can control permissions associated with the video or audio connection for the client device 120 of the confined individual (e.g., based on utilizing the secure communications system interface 126). In some embodiments, the secure communications system 102 may implement a private blockchain (e.g., corresponding to the gateway server) to implement one or more of the permission control features (e.g., using the legal counsel interface 106), and to also generate an immutable record of the associated communications between the legal counsel device 124 and the client device 120 during the secure video sessions or secure audio sessions.

For example, based on the permission control features, the secure communications system 102 can restrict access, by the client device 120 of the confined individual, of particular modified electronic legal documents, particular messaging thread interfaces, and other interface features associated with textual inputs. For instance, the due process services 112 of the secure communications system 102 can remove access, by the client device 120 of the confined individual, to textual inputs from the client device 120 or the legal counsel device 124 during the video conference (e.g., textual inputs into a messaging thread interface) upon the completion of the video conference or prior to the completion of the video conference. As another example, the secure communications system 102 can remove access, by the client device 120 of the confined individual, to modifications (e.g., annotations, highlights, comments, field entries, etc.) to an electronic legal document provided for display during the video conference upon completion of the video conference, prior to completion of the video conference, or within a threshold amount of time upon completion of the video conference.

In some embodiments, the secure communications system 102 may provide one or more encryptions (e.g., Diffie Hellman encryption, encryptions using an advanced encryption standard, etc.) for the video sessions or audio sessions. One or more keys associated with the encryptions for the video and audio sessions may be discarded (e.g., during the video conference) by rotations of new encryption keys (e.g., rotations after a threshold period of time). Additionally or alternatively, the secure communications system 102 can encrypt the video or audio session (e.g., during the video conference) using a plurality of different keys. In embodiments, the encrypted data associated with the secure video or audio sessions can be stored within the data store(s) 104.

In some embodiments, the data store(s) 104 may be a distributed database based on one or more blockchains having consensus-based validation. For example, one or more applications, deployed by the secure communications system 102 for due process services 112, on the legal counsel device 124, the client device 120, and client devices of the correctional facility systems 130A-130B can communicate with the one or more blockchains to access the due process services 112 (e.g., based on the correctional facility interface(s) 110 communicating with the secure communications system interfaces 134A-134B and based on the communication interfaces between the legal counsel interface 106 and client interface 108 with the corresponding secure communications system interfaces 122 and 126).

In some embodiments, the data store(s) 104 may include one or more cloud storage servers that store communication data, from the secure video sessions or secure audio sessions between the legal counsel device 124 and the client device 120, or other privileged (e.g., attorney-client privileged) or private data associated with the confined individual using one or more distributed hash tables. In some embodiments, one or more of the identifiers of the confined individual are mapped to particular communication data associated with a particular secure video session or secure audio session stored within a plurality of different distributed hash tables. In some embodiments, one or more of the identifiers of the confined individual are mapped to particular electronic legal resources within one or more distributed hash tables.

For example, the secure communications system 102 can receive a plurality of electronic legal resources from the legal resource data store(s) 116, which may be embodied as a single database, a distributed database, a database in the cloud, or another type of database. An electronic legal resource may include, for example, case law corresponding to one or more jurisdictions, federal or state statutes, state constitutions, ordinances, legal treatises, law review publications, legislation, restatements of law, other types of electronic legal resources, or one or more combinations thereof. For example, in some embodiments, the secure communications system 102 can receive one or more historical criminal records for the confined individual from the electronic legal data store(s) 116, and can also identify a plurality of electronic legal resources corresponding to a jurisdiction that has authority over the confined individual and corresponding to a particular legal proceeding associated with the confined individual. In some embodiments, the secure communications system 102 can receive actual court documents for a particular confined individual and provide those actual court documents and other electronic docket items into Video, hearings and meetings provided by the secure communications system 102.

In some embodiments, the secure communications system 102 can utilize one or more machine learning algorithms to identify the electronic legal resources (e.g., corresponding to the jurisdiction and the legal proceeding each associated with the confined individual). In some embodiments, a server that is separate from the secure communications system 102 may be used for identifying the electronic legal resources (e.g., based on labels or key terms associated with a particular jurisdiction and particular legal proceeding). The one or more machine learning algorithms may include, for example, supervised learning, unsupervised learning, semi-supervised learning, reinforcement learning, another type of learning, or one or more combinations thereof. In some embodiments, the one or more machine learning algorithms may include a deep neural network, a convolutional neural network, a recurrent neural network, a restricted Boltzmann machine, a deep belief network, a bidirectional recurrent deep neural network, a deep Q-network, another type of machine learning algorithm, or one or more combinations thereof. In some embodiments, the secure communications system 102 may include a software structure other than a hardware structure (e.g., a main processor, an auxiliary processor, etc.) for utilizing the one or more machine learning algorithms.

Providing particular electronic legal resources can help fully inform confined individuals on particular criminal charges, the consequences of particular actions during confinement, etc., which thereby enhances access for confined individuals to pertinent information relevant to their confinement through these technological embodiments discussed herein. For example, studies have shown that confined individuals have limited access to library resources (e.g., inappropriate library hours and inappropriate collections of materials), difficulty in obtaining relevant informational materials and audiovisual materials, etc. By way of illustration, studies have also shown that library resources focus on rehabilitation and fail to include materials about prison regulations and procedures and particular laws pertaining to particular jurisdictions. In addition, studies have also shown that these libraries are in need of better budgets, more trained personnel, and improved communication with other institutional staff and outside libraries. As another illustration, it would be highly unlikely for a particular correctional facility in a particular geographical jurisdiction (e.g., within the state of New York) to include legal resources within its library associated with Montana (e.g., for a confined individual who has legal charges in Montana). As such, by providing particular electronic legal resources (e.g., corresponding to a jurisdiction and legal proceeding) to confined individuals via the secure communications system 102, each of these issues (e.g., not providing access to materials about prison regulations and procedures and particular laws pertaining to particular jurisdictions) associated with the correctional facilities and the correctional facility systems can be remedied via the secure communications system 102.

Furthermore, the secure communications system 102 can utilize the one or more machine learning algorithms to identify electronic legal documents, corresponding to the jurisdiction and the legal proceeding each associated with the confined individual, for modification during a particular scheduled video conference for the confined individual. For example, for a scheduled parole interview video conference, the secure communications system 102 can identify and retrieve a particular legal document for the confined individual for generating a parole plan. For instance, during a video conference between legal counsel and the confined individual prior to the parole interview video conference, an electronic parole plan legal document identified by the secure communications system 102 can be edited, signed, or otherwise modified (e.g., by the confined individual or legal counsel) to include a planned place to live upon grant of parole, a potential place of employment upon grant of parole, etc. As another example, an electronic legal waiver document identified by the secure communications system 102 can be edited, signed, or otherwise modified during a video conference between legal counsel and the confined individual. In this way, the secure communications system 102 can reduce the steps and time in which it takes to receive signatures from confined individuals (e.g., since the secure communications system 102 has already received a confirmation via the correctional facility system) and reduce the difficulty of conveying particular information solely over a telephonic communication (e.g., by providing particular highlighted information within the electronic legal document, by annotating the electronic legal document, etc. via the video conference interface provided by the secure communications system 102).

In some embodiments, a knowledge graph stored within the data store(s) 104 can be used to associate profile data (e.g., of a particular confined individual) with particular jurisdictions, legal proceedings, legal resources, legal documents to be completed and signed, etc. For example, the knowledge graph can be modeled in a hierarchical structure having nodes and edges, such that the edges represent relationships between historical criminal records or criminal charges and a jurisdiction or legal proceeding. As another example, the knowledge graph can include relationships between keywords within legal documents associated with pending criminal charges and particular legal resources and legal documents corresponding to the particular jurisdiction. As another example, profile data for the confined individual may include prior addresses (e.g., home, work), education information, historical employment information, historical law suit data, birth date, information associated with family members (e.g., number of children and birth dates), other types of profile data for the confined individual, etc.

For example, some embodiments of the secure communications system 102 can include the due process services 112 of determining a jurisdiction associated with the confined individual for a legal proceeding involving the confined individual (e.g., based on key terms within legal documents for the legal proceeding, based on a knowledge graph stored at the data store(s) 104, based on inputs or uploaded documents provided by a legal counsel device, etc.). Based on the jurisdiction, the secure communications system 102 can identify one or more electronic legal resources corresponding to the jurisdiction and the legal proceeding involving the confined individual. For example, the secure communications system 102 can identify federal or state statutes, constitutions, or ordinances that apply to the legal proceeding involving the confined individual, legal treatises, law review publications, or restatements of law that apply to the legal proceeding involving the confined individual, other types of electronic legal resources that apply to the legal proceeding involving the confined individual, or one or more combinations thereof. In some embodiments, the secure communications system 102 can receive one or more electronic legal resources based on the legal counsel device 124 interacting with the legal resource data store(s) 116.

The secure communications system 102 can also provide the one or more electronic legal resources identified (e.g., using the knowledge graph stored at the data store(s) 104, using one or more machine learning algorithms, using a server separate from the secure communications system 102, etc.) to a user interface (e.g., the secure communications system interface 126) of the legal counsel device 124. For example, the secure communications system 102 may provide a plurality of electronic legal resources identified for selection by the legal counsel device 124 (or another type of indication by the legal counsel device 124) to be provided to the client device 120 for the confined individual via the secure communications system interface 122. In this way, the secure communications system 102 can transmit one or more of the electronic legal resources to the client device 120 based on providing the identified electronic legal resources to the legal counsel device 124. For example, the one or more of the electronic legal resources may be transmitted to the client device 120 prior to the completion of a scheduled video conference for the confined individual. As another example, the one or more of the electronic legal resources may be transmitted to the client device 120 prior to the initiation of a scheduled video conference for the confined individual.

In some embodiments, the secure communications system 102 can store an amount of time of each video or audio conference for the confined individual (e.g., within the data store(s) 104). For example, the secure communications system 102 can track a total amount of time that the confined individual has spent with an attorney on an audio or video conference. By way of example, some studies have shown that an estimated 58% of State inmates who employed their own attorneys and 65% of Federal inmates who employed their own attorneys talked with their attorneys four or more times about their charges compared to inmates having court-appointed attorneys. Due in part to these statistics, in some embodiments, the secure communications system 102 can compare an amount of time that court-appointed attorneys spent with confined individuals to an amount of time that privately employed attorneys spent with confined individuals. For example, the secure communications system 102 can identify court-appointed attorneys and privately employed attorneys using legal counsel profile data stored within the data store(s) 104.

Furthermore, because some confinement facilities (or a government department, for example) may require the reporting on time that legal counsel spent with a confined individual, the secure communications system 102 can automatically store (e.g., within the data store(s) 104) an amount of time for each audio or video conference upon the completion of the audio or video conference. In some implementations of this embodiment, the secure communications system 102 can then transmit the amount of time of the audio or video conference (or an accumulated amount of time for each audio and video conference) to the correctional facility system associated with the confined individual. In some instances, the secure communications system 102 can transmit the amount of time or the accumulated amount of time to the correctional facility via email. Additionally, in some embodiments, the secure communications system 102 can transmit this information based on receiving a request from the correctional facility system (e.g., via a secure communications system interface) for the associated amount of time.

In some embodiments, the secure communications system 102 can perform various operations (e.g., due process services 112) based on the confined individual transferring to another correctional facility (e.g., the confined individual transferring from a correctional facility corresponding to the correctional facility system 130A to another correctional facility associated with correctional facility system 130B). For example, the secure communications system 102 may receive an indication from the correctional facility system 130A (e.g., via secure communications system interface 134A), from the legal counsel device 124, or from the client device 120 that the confined individual is transferring to the correctional facility associated with the correctional facility system 130B. As another example, the secure communications system 102 may determine that the confined individual is transferring to the correctional facility associated with the correctional facility system 130B based on one or more documents uploaded or received via the secure communications system interface 122, 126, or 134A (e.g., determined via one or more natural language processing techniques). In some embodiments, the secure communications system 102 can determine or identify a transfer date and time associated with the confined individual being transferred (e.g., an expected date of arrival to the next correctional facility, an expected date of departure from the correctional facility associated with the correctional facility system 130A, etc.).

In some embodiments, based on the confined individual being transferred to the correctional facility associated with the correctional facility system 130B, the secure communications system 102 can automatically update scheduled audio or video conferences for the confined individual. By way of example, the secure communications system 102 can transmit requests and notifications associated with the scheduled audio or video conferences to the correctional facility system 130B. For example, the notifications or requests can include the one or more legal counsel identifiers and one or more identifiers for the confined individual. Additionally, the notifications or requests can include details associated with the scheduled audio or video conferences (e.g., date, time, expected duration, presence of an interpreter, etc.).

Based on transmitting a notification or request associated with the confined individual to the correctional facility system 130B, a confirmation can be received by the secure communications system 102 from the correctional facility system 130B (e.g., via the secure communications system interface 134B). The confirmation from the correctional facility system 130B may be associated with the one or more legal counsel identifiers and the one or more identifiers for the confined individual. Further, based on receiving the confirmation from the correctional facility system 130B, the secure communications system 102 can update an administrative portal for the correctional facility system 130B to include a date and time of the video or audio conference, an expected duration of the video conference, and at least one of the one or more identifiers for the confined individual. In some embodiments, the secure communications system 102 can receive one or more new identifiers for the confined individual based on the confinement of the individual being located within the confinement facility corresponding to the correctional facility system 130B. In addition, the secure communications system 102 can schedule additional audio or video conferences or update previously scheduled audio or video conferences for the confined individual based on the new identifiers.

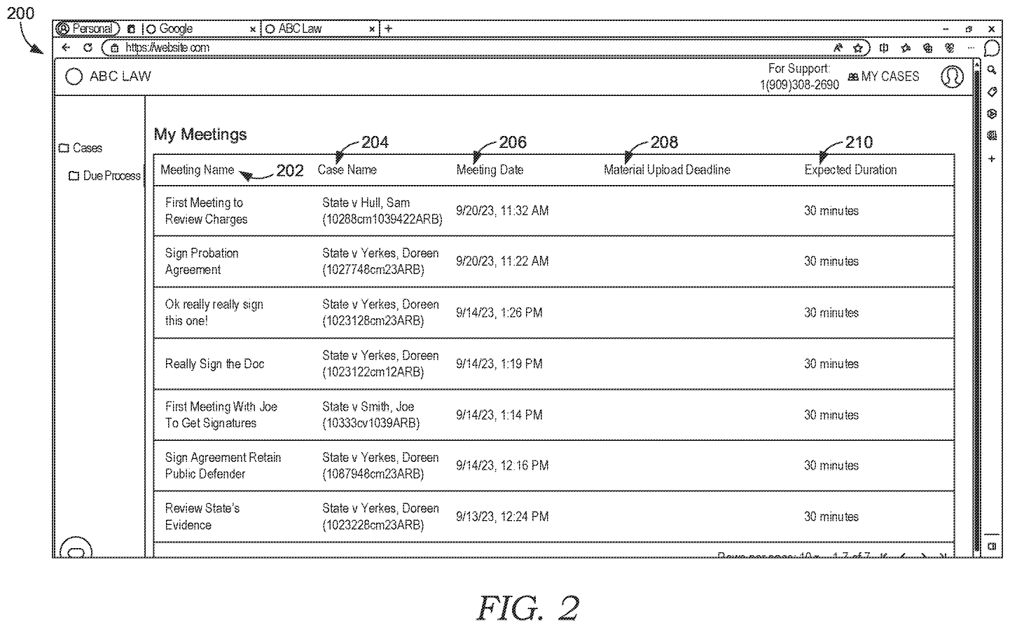

FIG. 2 provides an example secure communications system user interface 200 that the secure communications system 102 of FIG. 1 can provide to the legal counsel device 124 via the secure communications system interface 126. By way of example, the secure communications system user interface 200 can include a column for meeting names 202 (e.g., generated by the secure communications system 102 via inputs received at the secure communications system interface 126). The secure communications system user interface 200 can also include a column for case names 204 (e.g., generated by the secure communications system 102 based on inputs received at the secure communications system interface 126, based on using natural language processing techniques on legal documents corresponding to a legal proceeding for the confined individual and uploaded by the legal counsel device 124 or correctional facility system, etc.). The secure communications system user interface 200 can also include a column for dates and times of meetings 206 (e.g., scheduled audio or video conferences with the confined individual), a column for deadlines associated with uploading particular electronic documents 208 (e.g., electronic legal resources or electronic legal documents to be signed by the confined individual), and a column for an expected duration of the audio or video conference 210.

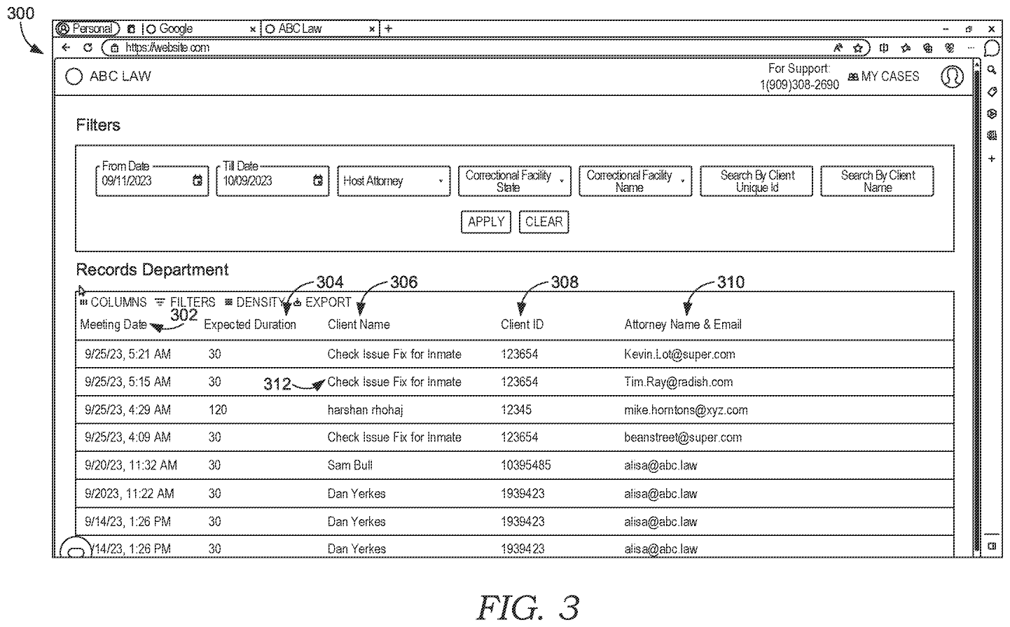

FIG. 3 illustrates an example administrative portal 300 that can be generated by the secure communications system 102 of FIG. 1 for correctional facility systems (e.g., correctional facility system 130A, correctional facility system 130B). For example, the administrative portal 300 can include a column for a date and time of scheduled audio or video conferences of confined individuals 302, a column for an expected duration of the audio or video conference 304, a column that includes the name of the confined individual having the scheduled audio or video conference 306, a column for a unique identifier generated by the correctional facility system for the confined individual 308, and a column for an email address for the legal counsel associated with the scheduled audio or video conference 310. In embodiments, the administrative portal 300 can be displayed via the secure communications system interface 134A or 134B.

In some embodiments, the secure communications system 102 may generate an indication of a detected issue 312 associated with the confined individual. For example, the detected issue can correspond to a particular identifier for the confined individual (e.g., overlapping identifiers generated by the correctional facility for confined individuals, a detected transfer of the confined individual prior to the date of a scheduled audio or video conference, etc.), which may be displayed via the administrative portal 300 at the column that includes the name of the confined individual 306 (or another column). In some embodiments, the secure communications system 102 may also transmit a notification to the legal counsel device 124 based on the detected issue. The administrative portal 300 can be used by the correctional facilities so that the confined individual can have access to client device 120 during the scheduled audio or video conference.

In embodiments, one or more users of the correctional facility system 130A or correctional facility system 130B may filter scheduled audio or video conferences for confined individuals within the associated correctional facility. For example, a user may filter by date, a hosting attorney, identifiers for the confined individual, or name of the confined individual. In some embodiments, one or more of these filters may be applied simultaneously.

FIG. 4 includes example user interface 400 generated by the secure communications system 102 for legal counsel devices and client devices to generate a profile. Profiles may be generated for the confined individual, legal counsel (e.g., a public defender, district attorney), a parole board member, an interpreter, or another entity associated with the legal proceeding for the confined individual. For example, in some embodiments, audio or video conferences can be scheduled using a profile for the confined individual and a profile for the legal counsel. In some embodiments, a parole interview video conference can be scheduled (e.g., via the legal counsel device 124 or a correctional facility system) using a profile for the confined individual and a profile for the parole board member.

By way of example, profile data for the confined individual may include one or more identifiers for the confined individual, prior addresses, prior legal counsel information (e.g., of attorneys who previously represented the confined individual in other legal proceedings), education information, historical employment information, historical law suit data, birth date, other types of profile data for the confined individual, etc. In addition, profile data for the legal counsel may include an address and email address, previous legal names of the legal counsel, phone number, previous client data, bar license number(s), court admission documents, an image identifier of the attorney, legal documents or agreements associated with the confined individual, other types of profile data, or one or more combinations thereof. In some embodiments, columns within the administrative portal 300 of FIG. 3 may be automatically populated by the secure communications system 102 based on profiles generated via user interface 400. In some embodiments, an electronic legal document for a legal proceeding corresponding to the confined individual may be automatically populated by the secure communications system 102 based on a profile for the confined individual (e.g., generated via user interface 400).

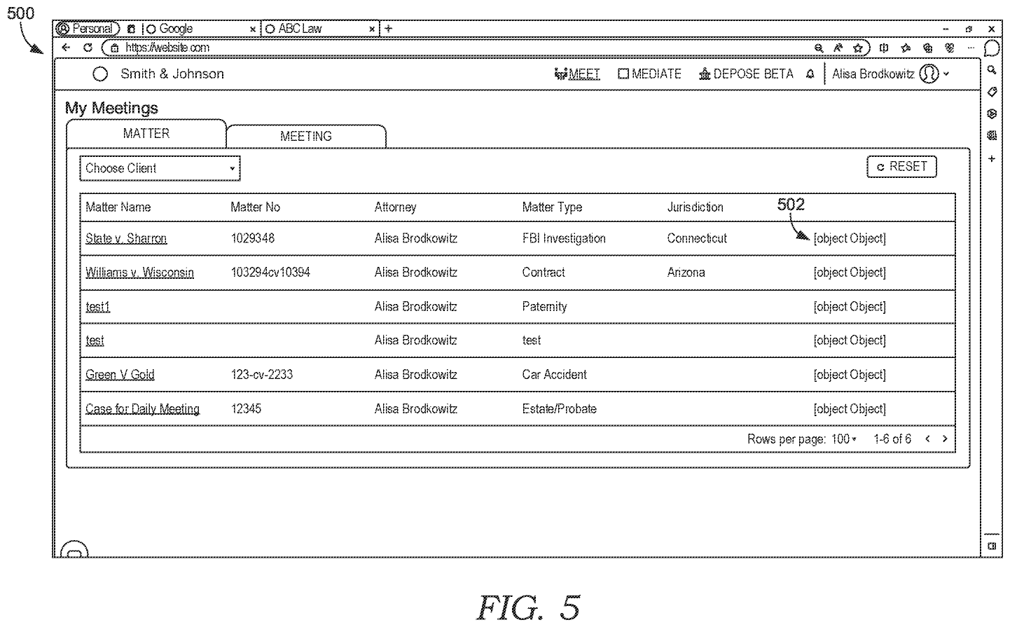

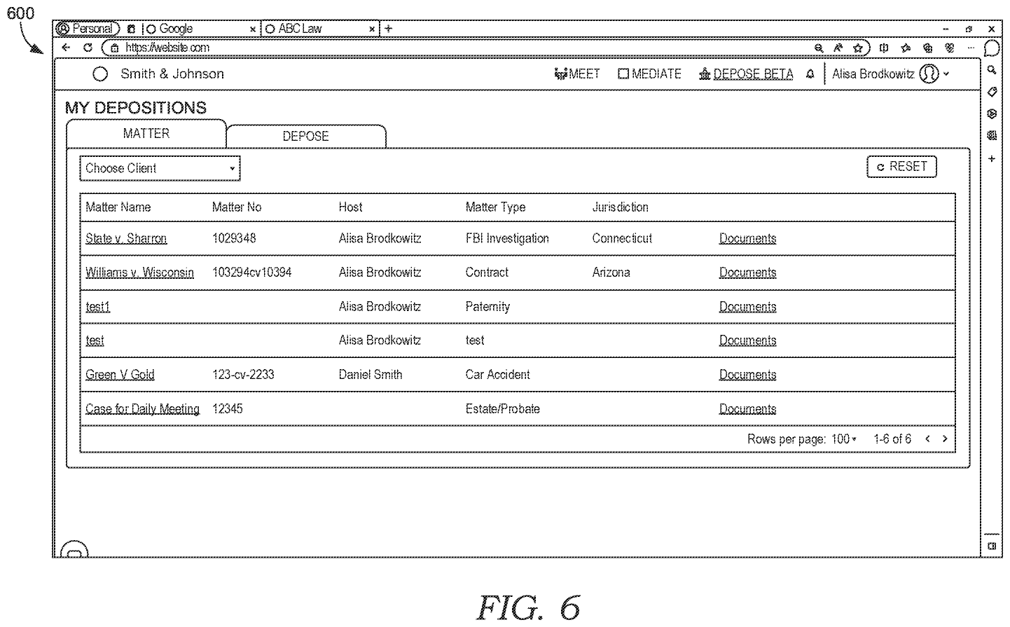

FIG. 5 illustrates an example secure communications system user interface 500 that can be generated by the secure communications system 102 of FIG. 1 for legal counsel devices (e.g., legal counsel device 124 via secure communications system interface 126). In embodiments, the secure communications system user interface 500 may list scheduled audio or video conferences for a particular legal counsel device by date and time of the scheduled audio or video conferences. The legal counsel may also filter the scheduled audio or video conferences using a client name, matter number, jurisdiction (e.g., state), unique identifiers for the confined individual, etc. The secure communications system user interface 500 may include columns for a matter name, matter number, matter type, jurisdiction, as well as a link to associated electronic legal documents and resources 502. In some embodiments, the secure communications system user interface 500 may provide notifications for upcoming scheduled audio or video conferences. In addition, the secure communications system 102 can provide example secure communications system user interface 600 illustrated in FIG. 6 for scheduled audio or video deposition conferences.

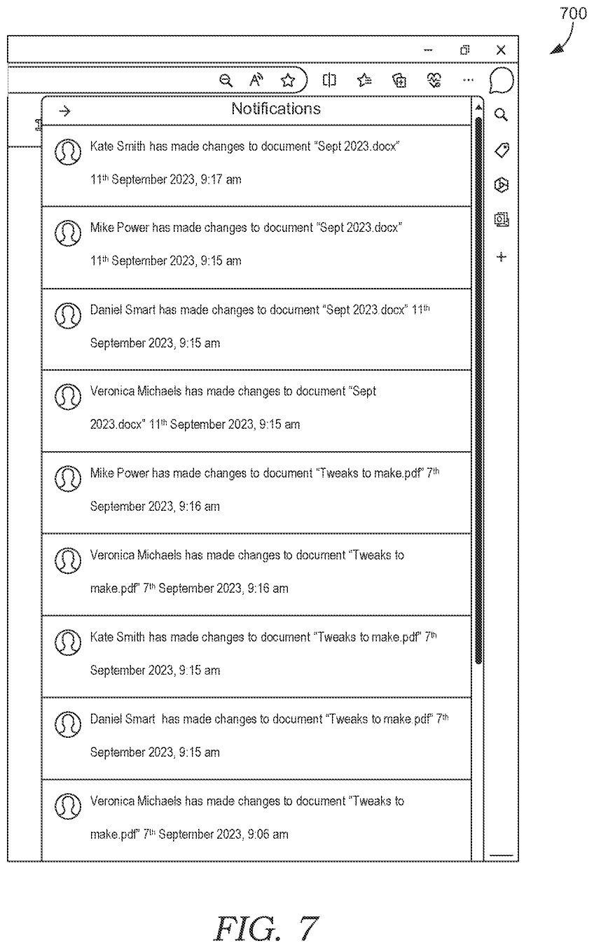

FIG. 7 illustrates an example secure communications system user notification interface 700 that can be generated by the secure communications system 102 of FIG. 1 for legal counsel devices (e.g., legal counsel device 124 via secure communications system interface 126). For example, the secure communications system 102 can provide notifications to the legal counsel device 124 via secure communications system interface 126 based on modifications to electronic legal resources or documents by client device 120 via the secure communications system interface 122. For example, the modifications may be made by a paralegal, a confined individual, a translator, another entity corresponding to a legal proceeding for the confined individual, or one or more combinations thereof. The secure communications system user notification interface 700 can also indicate which electronic legal resource or document was modified, and can also provide a selectable link to the electronic legal resource or document (e.g., the electronic legal resource or document before the modification(s) or after the modification(s)). In some embodiments, selection of the selectable link via the secure communications system interface 126 can provide indications to specific modifications.

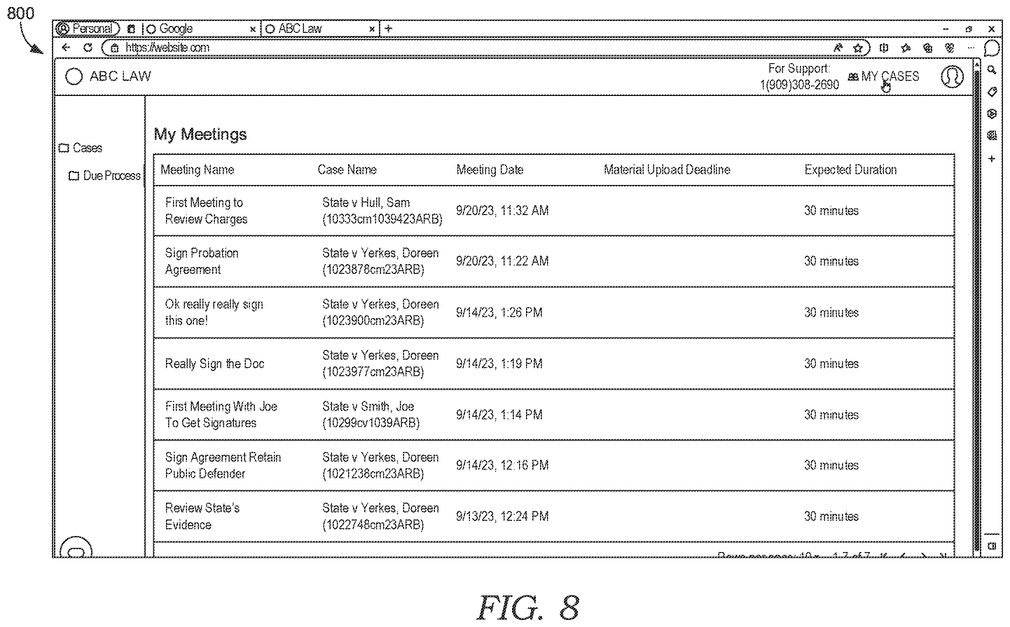

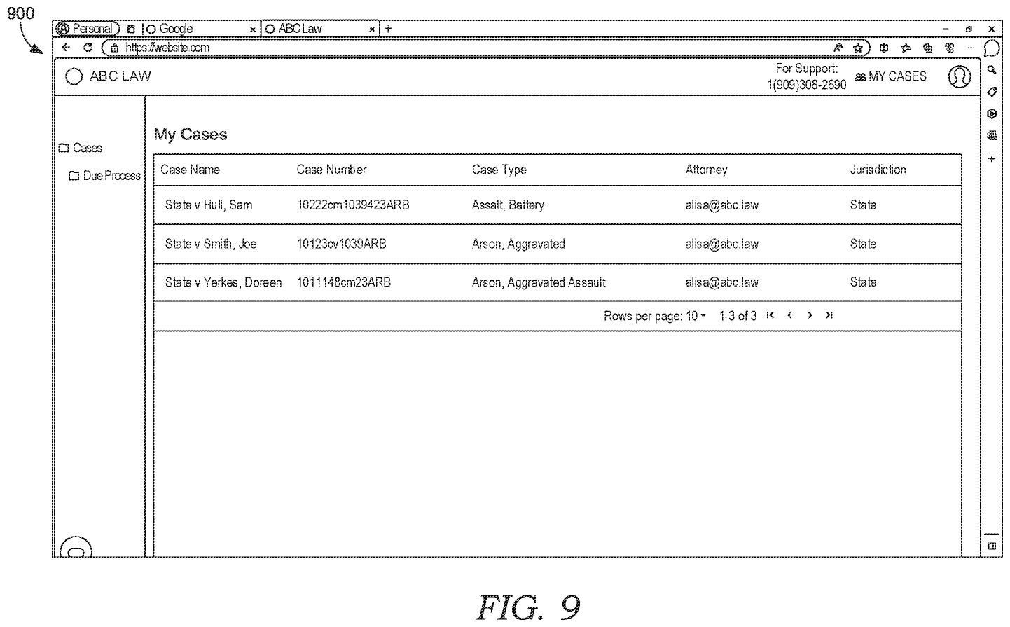

FIGS. 8-9 include additional example secure communications system user interfaces 800 and 900 generated by the secure communications system 102 for legal counsel devices (e.g., legal counsel device 124 via secure communications system interface 126). For example, secure communications system user interface 800 includes a list of scheduled audio or video conferences for a particular legal counsel profile and the secure communications system user interface 900 includes a list of cases. For example, the secure communications system user interface 900 may include a case name, case number, case type (e.g., assault, battery), and jurisdiction (e.g., a particular state). In some embodiments, the secure communications system user interface 900 may include an indication that an audio or video conference has been scheduled or an indication that an audio or video conference should be scheduled by a particular date.

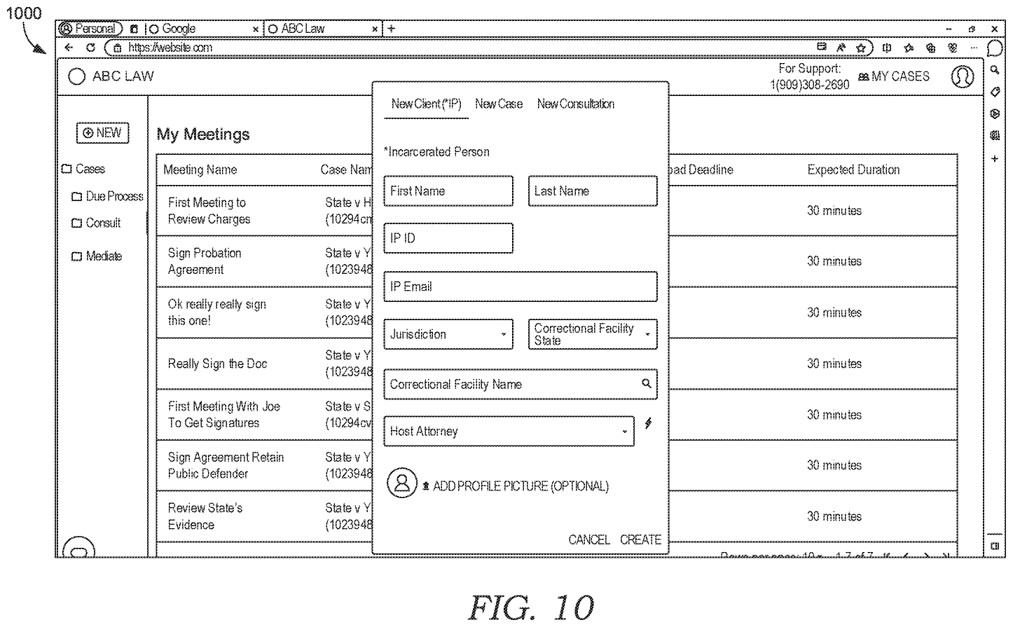

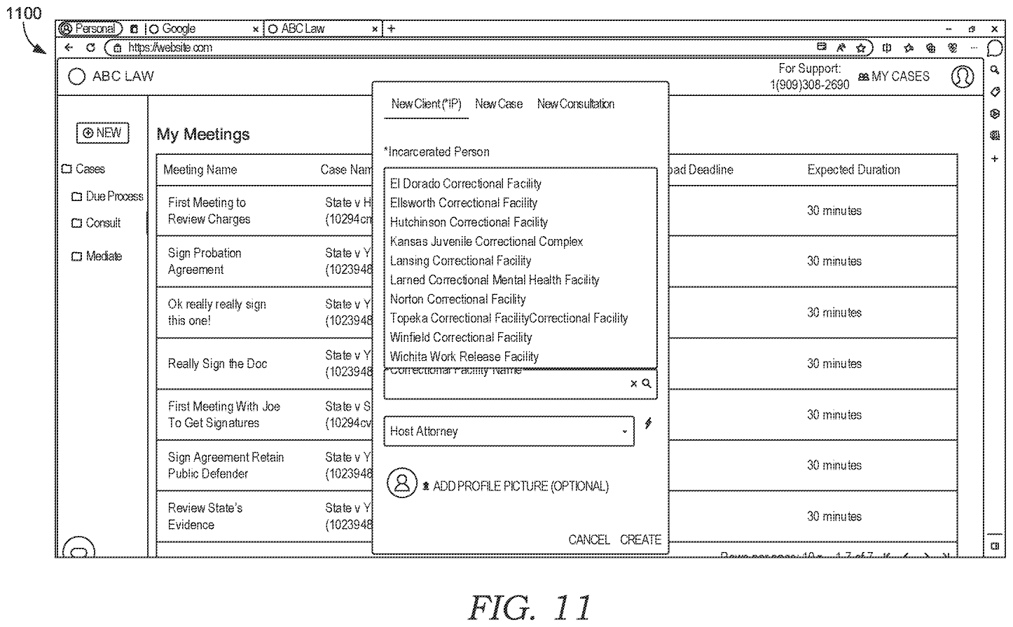

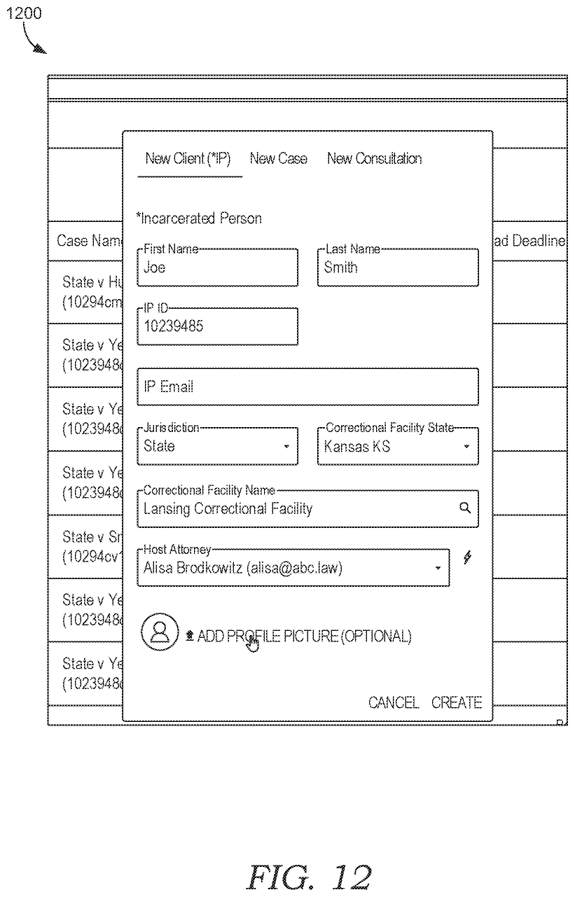

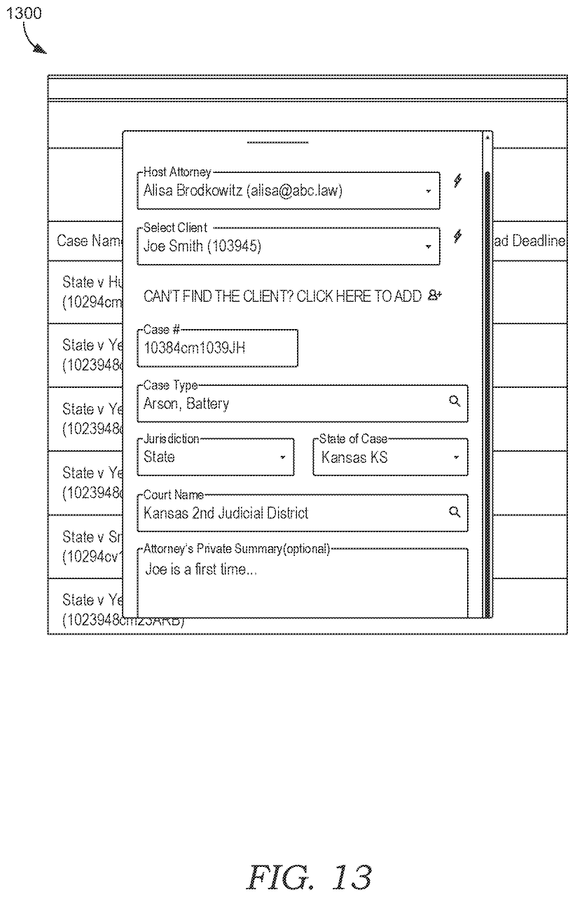

FIGS. 10-13 include example secure communications system user interfaces 1000, 1100, 1200, and 1300 for scheduling an audio or video conference for a confined individual (e.g., using the legal counsel device 124 and secure communications system interface 126). To schedule the audio or video conference for the confined individual, the secure communications system 102 may receive a first and last name of the confined individual, an identifier for the confined individual, an email associated with the confined individual, a jurisdiction for the confined individual, a correctional facility state for the confined individual, a correctional facility name, a host attorney identifier (e.g., name and email), and/or a photo associated with a profile corresponding to the audio or video conference. In some embodiments, the secure communications system 102 can automatically populate a list of correctional facility names (e.g., for selection via the legal counsel device 124) upon receiving the correctional facility state, as illustrated in secure communications system user interface 1100. In some embodiments, as illustrated in secure communications system user interface 1300, the audio or video conference may be scheduled based on entry, via the secure communications system interface 126, of a case number, case type, and/or court name. Furthermore, specific notes for the audio or video conference may be entered, as illustrated in secure communications system user interface 1300.

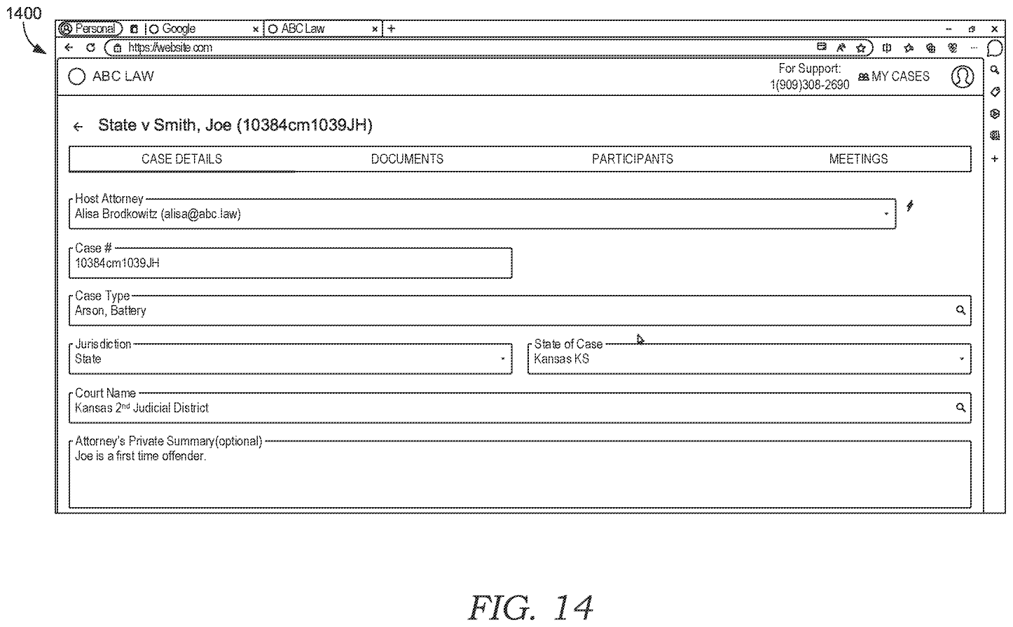

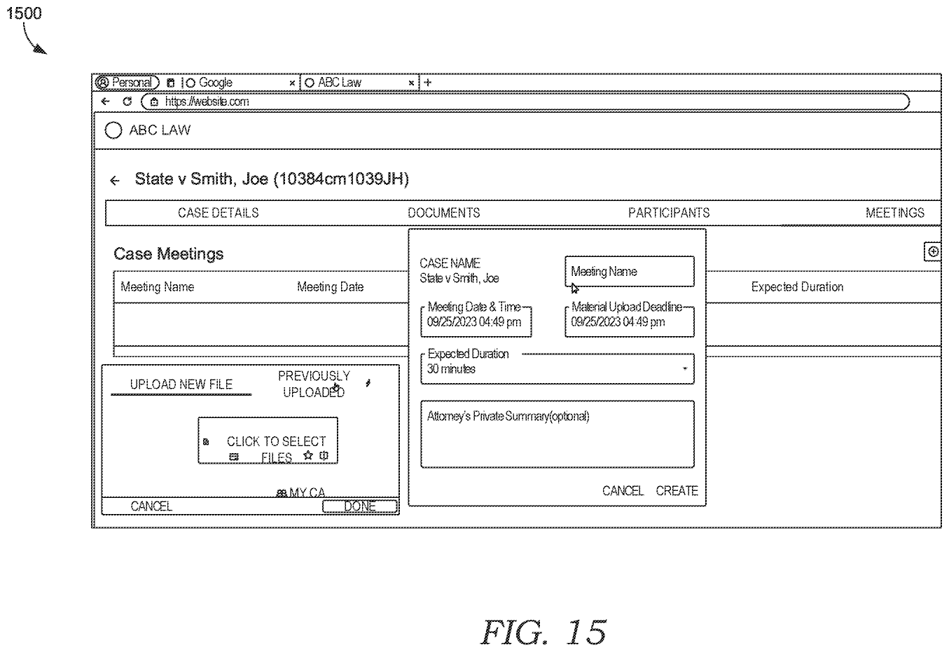

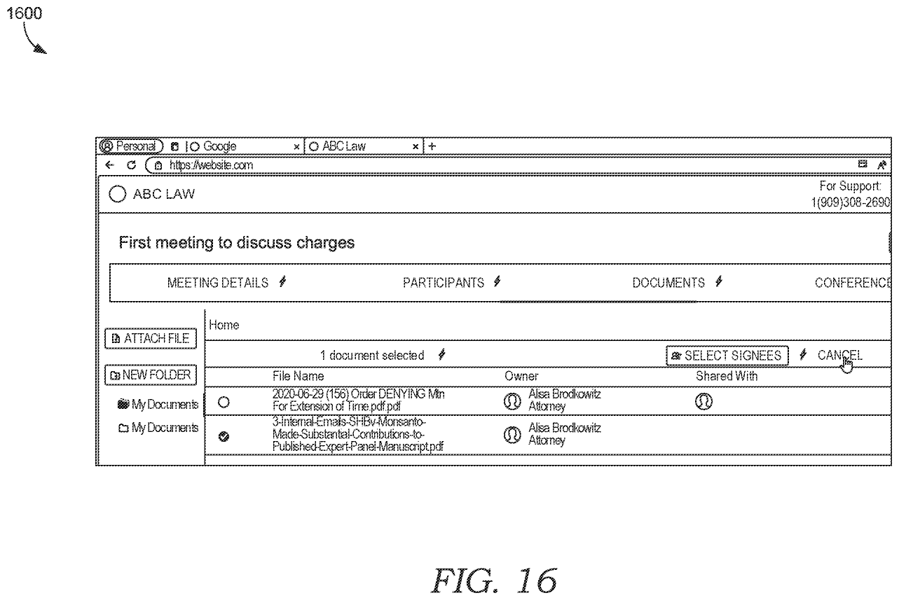

FIG. 14 depicts example secure communications system user interface 1400 that may be provided via the secure communications system 102 via secure communications system interface 126 for presenting particular case details to the legal counsel, and FIG. 15 depicts example secure communications system user interface 1500 for generation of the particular case details. FIG. 16 depicts additional example secure communications system user interfaces associated with particular legal documents associated with a legal proceeding for the confined individual.

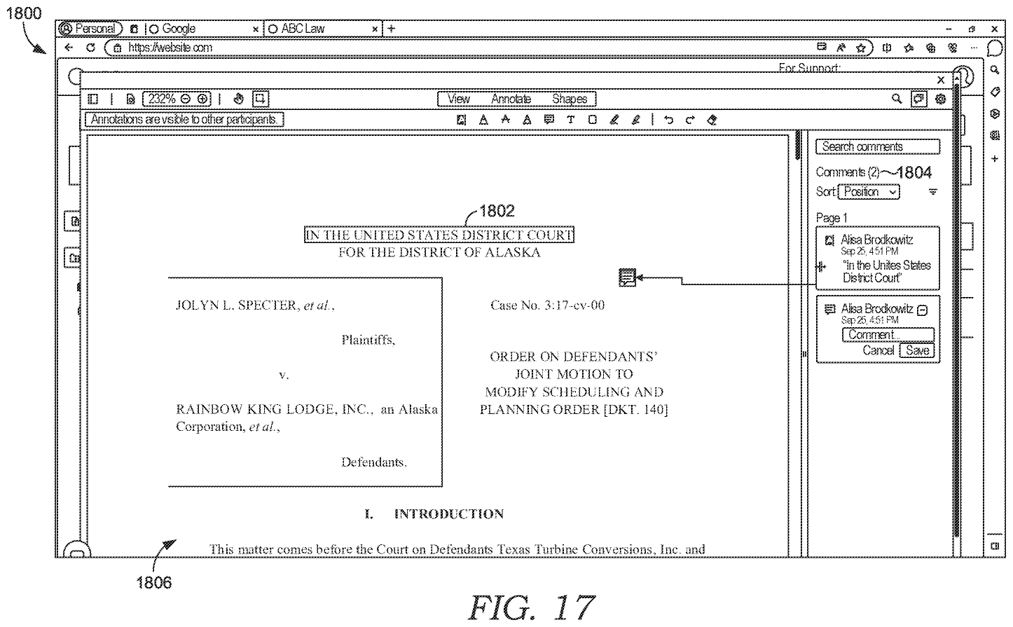

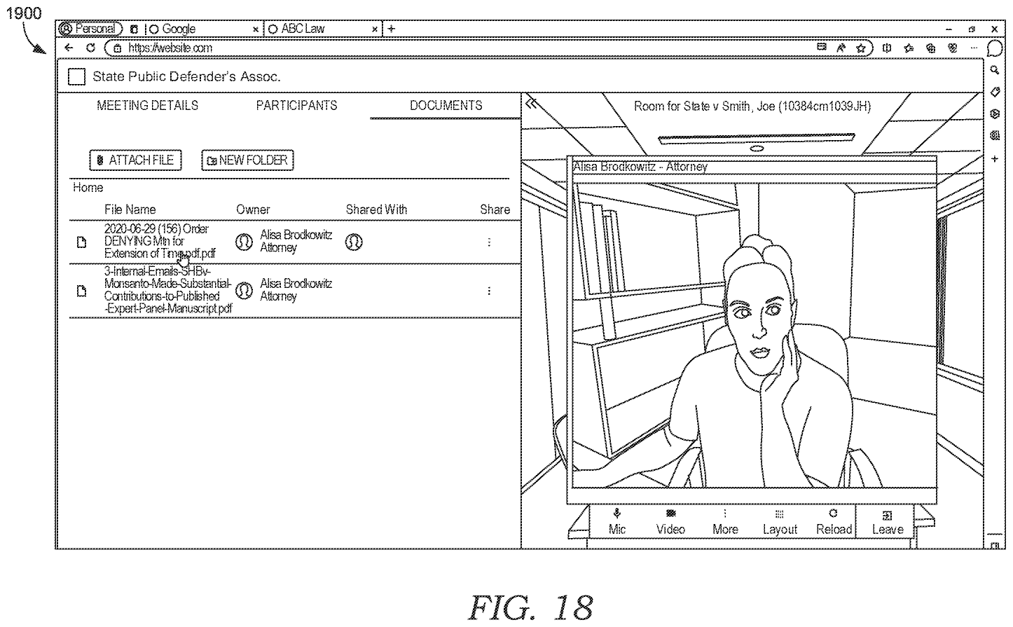

FIG. 17 illustrates an example electronic legal document 1806 having modifications (e.g., modified during or before a scheduled video conference). For example, the modifications in example secure communications system user interface 1800 includes highlighting 1802 and comments 1804 provided by the legal counsel device. The modified electronic legal document 1806 may be shared by the legal counsel device with the confined individual during a video conference. For example, FIG. 18 provides an example secure communications system user interface 1900 for a video conference. Upon completion of the video conference, the secure communications system 102 can remove access to the highlighting 1802 and the comments 1804 from the client device of the confined individual. For example, in some embodiments, the client device of the confined individual may still have access to the pre-modified electronic legal document (e.g., the same electronic legal document but without the highlighting 1802 and the comments 1804). As another example, the client device of the confined individual can also be restricted from modifying the electronic legal document.

### Example Flowchart

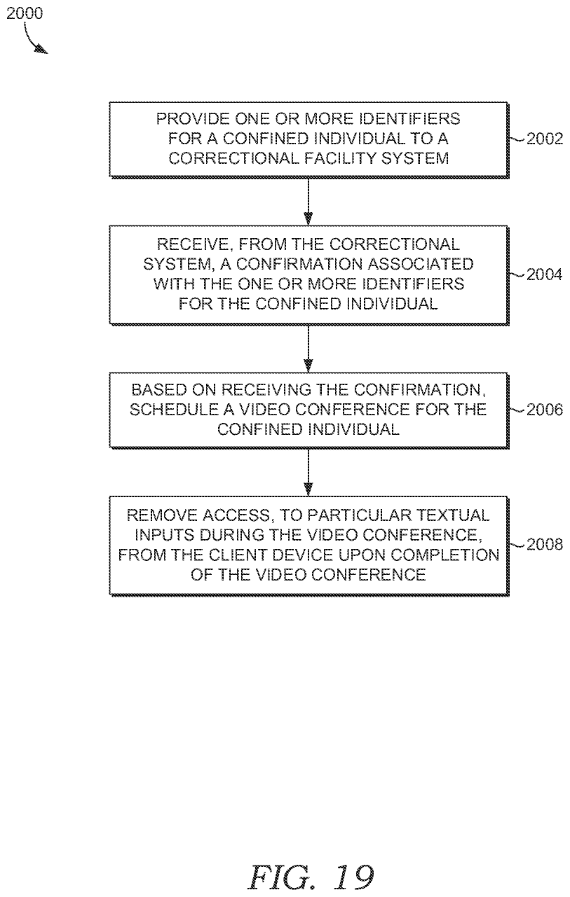

Having described the example embodiments discussed above of the presently disclosed technology, an example flowchart is described below with respect to FIG. 19. Although the term “step” may be used herein to connote different elements of methods employed, this term should not be interpreted as implying any particular order among or between various steps herein disclosed unless and except when the order of individual steps is explicitly described.

For example, FIG. 19 begins at step 2002 with providing one or more identifiers for a confined individual to a correctional facility system. In some embodiments, one or more legal counsel identifiers, one or more translator identifiers, one or more parole board member identifiers, or other identifiers corresponding to an entity associated with a legal proceeding for the confined individual may be provided to the correctional facility system. For example, the identifiers may be provided electronically between the correctional facility system and a secure communications system, by fax to the correctional facility (e.g., and by entry into the correctional facility system), by certified mail to the correctional facility, etc.

Based on providing the one or more identifiers to the correctional facility system, at step 2004, the secure communications system can receive, from the correctional facility system, a confirmation associated with the one or more identifiers (e.g., for the confined individual, legal counsel, interpreter, etc.). In some embodiments, the confirmation can be received from the correctional facility via a fax transmission, a secure communications system interface and correctional facility interface, or physical mail. For example, the physical mail or fax received from the correctional facility can be uploaded to the secure communications system and stored within a data store of the secure communications system. In some embodiments, the secure communications system can verify the confirmation by utilizing one or more blockchains, a signature block of the confirmation associated with the correctional facility, and the one or more identifiers for the confined individual.

Based on receiving the confirmation, at step 2006, the secure communications system can transmit a request to the correctional facility system to schedule a video or audio conference (e.g., a parole interview video conference, a pre-trail video conference between the confined individual and an attorney, a sentencing video conference between the confined individual and attorney, etc.) for the confined individual, schedule the video or audio conference for a particular day, time, and duration, provide one or more electronic legal resources to the confined individual via a client device (e.g., provided prior to the completion of the video conference), provide one or more secure communications system interfaces, etc., or one or more combinations thereof.

In some embodiments, a legal counsel device can provide an indication to the secure communications system to include an interpreter for the confined individual during the video or audio conference (e.g., based on permission control features of the legal counsel device). As another example, the secure communications system may receive an indication to include an interpreter for a particular parole interview video conference. Based on the indication, the secure communications system may provide a computer device associated with the interpreter and the one or more interpreter identifiers access to the audio or video conference. In some embodiments, the access may be provided based on the secure communications system verifying one or more interpreter identifiers (e.g., received by the secure communications system from the legal counsel device or the computer device associated with the interpreter). Additionally or alternatively, the access may be provided based on receiving a confirmation from the correctional facility system for the interpreter.

In some embodiments, based on scheduling the video or audio conference, the secure communications system can update an administrative portal for the correctional facility system (e.g., the administrative portal of FIG. 3) to include a date and time of the video conference, an expected duration of the video conference, at least one of the one or more identifiers for the confined individual, etc., or one or more combinations thereof. Additionally or alternatively, based on scheduling the video conference and prior to initiating the video conference, the secure communications system may cause the transmission of a notification to the correctional facility system, the notification including a date and time of the video conference, an expected duration, and at least one of the one or more identifiers for the confined individual.

Based on scheduling the video or audio conference, the secure communications system can initiate the video or audio conference (e.g., between a legal counsel device associated with the one or more legal counsel identifiers and a client device associated with the one or more identifiers for the confined individual, between the client device utilized by the confined individual and a client device of an interpreter, between the client device utilized by the confined individual and a client device of a parole board member, etc.). In some embodiments, a parole interview video conference can be initiated between at least one client device corresponding to at least one parole board member and a client device corresponding to the confined individual, wherein the parole interview video conference is initiated based on one or more identifiers for the confined individual and one or more identifiers for the at least one parole board member.

By way of example, the audio or video conference can be initiated based on receiving log-in credentials (e.g., including biometrics, such as a thumbprint) for the confined individual on the client device and based on receiving biometrics of the legal counsel, parole board member, or another entity associated with the legal proceeding for the confined individual. As another example, the audio or video conference can be initiated based on the secure communications system utilizing one or more blockchains to verify the one or more legal counsel identifiers, one or more identifiers for the confined individual, one or more identifiers for another entity associated with the legal proceeding for the confined individual, or one or more combinations thereof. In yet another example, the audio or video conference can be initiated based on an SSO (e.g., a cloud-based or web-based SSO system) by the confined individual and one or more entities associated with the audio or video conference.

In some embodiments, the video or audio conference may be initiated for the confined individual based on comparing facial features of the confined individual from a camera of a client device (e.g., that the confined individual logged into using one or more identifiers for the confined individual) to a photo identifier of the confined individual. For example, the secure communications system can have one or more photo identifiers of the confined individual stored within one or more data stores of the secure communications system. Further, the secure communications system can implement one or more facial recognition techniques to identify particular patterns (e.g., corresponding to nose, eyes, mouth, etc.) within an image or video captured by the client device prior to initiating the video or audio conference for the confined individual. For example, the secure communications system can comparing facial features, such as a distance between the eyes, nose shape, and other facial features from the camera data and the one or more photo identifiers.

During the video conference, the secure communications system can provide, via secure communications system interfaces, one or more electronic legal documents for modification, a messaging thread interface, one or more electronic legal resources, other functionalities, or one or more combinations thereof. For example, during a scheduled video conference, the secure communications system can provide a messaging thread interface that receives one or more textual inputs (or other types of inputs) via one or more participants of the video conference. As another example, during a scheduled video conference, the secure communications system can allow one or more participants to modify one or more electronic legal documents. For example, the legal counsel device may provide a particular electronic legal document with annotations and highlighting, and the confined individual may, via the client device, fill in particular fields and sign the electronic legal document based on the highlighting and the annotations.

In some embodiments, during the video conference, the secure communications system can automatically populate one or more electronic legal documents corresponding to a legal proceeding for the confined individual. For example, the one or more electronic legal documents can be automatically populated based on a profile for the confined individual. As another example, the one or more electronic legal documents can be automatically populated based on historical legal documents for the confined individual (e.g., historical legal documents previously filled in by the confined individual and uploaded to the secure communications system, historical legal records of the confined individual, etc.).

At 2008, the secure communications system removes access, to the modified electronic legal documents and the messaging thread interface, from the client device upon completion of the video conference or before completion of the video conference. For example, the secure communications system can remove access, to one or more textual inputs at the messaging thread interface, from the client device upon completion of the video conference and without removing access from the legal counsel device to the one or more textual inputs. As another example, the secure communications system can remove access, to one or more modified electronic legal documents, from the client device upon completion of the video conference and without removing access from the legal counsel device to the one or more modified electronic legal documents. In some embodiments, the confined individual can still have access to the secure communications system after release from confinement.

### Example Client Device

An example operating environment of an example client device (e.g., client device 120 or legal counsel device 124 of FIG. 1) is described below with respect to FIG. 20. Client device 2100 is but one example of a suitable computing environment and is not intended to suggest any particular limitation as to the scope of use or functionality of the technology disclosed. Neither should client device 2100 be interpreted as having any dependency or requirement relating to any particular component illustrated, or a particular combination of the components illustrated in FIG. 20.

As illustrated in FIG. 20, example client device 2100 includes a bus 2102 that directly or indirectly couples the following devices: memory 2104, one or more processors 2106, one or more presentation components 2108, one or more input/output (I/O) ports 2110, one or more I/O components 2112, a power supply 2114, and one or more radios 2116.

Bus 2102 represents what may be one or more busses (such as an address bus, data bus, or combination thereof). Although the various blocks of FIG. 20 are shown with lines for the sake of clarity, in reality, these blocks represent logical, not necessarily actual, components. For example, one may consider a presentation component, such as a display device, to be an I/O component. Also, processors have memory. Accordingly, FIG. 20 is merely illustrative of an example client device that can be used in connection with one or more embodiments of the technology disclosed herein.

User device 2100 can include a variety of computer-readable media. Computer-readable media can be any available media that can be accessed by client device 2100 and may include both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information, such as computer-readable instructions, data structures, program modules, or other data. Computer storage media includes, but is not limited to, RAM, ROM, EEPROM, flash memory or other memory technology, CD-ROM, digital versatile disks (DVDs) or other optical disk storage, magnetic cassettes, magnetic tape, magnetic disk storage or other magnetic storage devices, or any other medium which can be used to store the desired information and which can be accessed by user device 2100. Computer storage media does not comprise signals per se.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, RF, infrared, and other wireless media. One or more combinations of any of the above should also be included within the scope of computer-readable media.

Memory 2104 includes computer storage media in the form of volatile and/or nonvolatile memory. The memory 2104 may be removable, non-removable, or a combination thereof. Example hardware devices of memory 2104 may include solid-state memory, hard drives, optical-disc drives, other hardware, or one or more combinations thereof. As indicated above, the computer storage media of the memory 2104 may include RAM, Dynamic RAM, ROM, EEPROM, flash memory or other memory technology, CD-ROM, a cache memory, DVDs or other optical disk storage, magnetic cassettes, magnetic tape, magnetic disk storage or other magnetic storage devices, a short-term memory unit, a long-term memory unit, any other medium which can be used to store the desired information and which can be accessed by user device 2100, or one or more combinations thereof.

The one or more processors 2106 of client device 2100 can read data from various entities, such as the memory 2104 or the I/O component(s) 2112. The one or more processors 2106 may execute, for example, software to control one or more components of the client device 2100. In addition, the one or more processors 2106 can execute instructions, for example, of an operating system of the user device 2100 or of one or more suitable applications. Further, the one or more processors 2106 may include, for example, one or more microprocessors, one or more CPUs, a digital signal processor, one or more cores, a host processor, a controller, a chip, a microchip, one or more circuits, a logic unit, an integrated circuit, an application-specific integrated circuit, any other suitable multi-purpose or specific processor or controller, or one or more combinations thereof. In some embodiments, the one or more processors 2106 may include a main processor (e.g., a central processing unit, an application processor), an auxiliary processor (e.g., a graphics processing unit, an image signal processor, a sensor hub processor, a communication processor) that is operable independently from, or in conjunction with, the main processor, another type of processor, or one or more combinations thereof. Additionally or alternatively, the auxiliary processor may be adapted to consume less power than the main processor. In some embodiments, the auxiliary processor may be specific to a specified function. In some embodiments, the auxiliary processor may be implemented as separate from, or as part of the main processor.

The one or more presentation components 2108 can present data indications via user device 2100, another user device, or a combination thereof. Example presentation components 2108 may include a display device (e.g., adapted to detect a touch), speaker, a hologram component, a printing component, sensor circuitry (e.g., a pressure sensor capable of measuring an intensity of force incurred by a touch), a vibrating component, a projector and control circuitry, another type of presentation component, or one or more combinations thereof. In some embodiments, the one or more presentation components 2108 may comprise one or more applications or services on a user device, across a plurality of user devices, or in the cloud. The one or more presentation components 2108 can generate user interface features, such as graphics, buttons, sliders, menus, lists, prompts, charts, audio prompts, alerts, vibrations, pop-ups, notification-bar or status-bar items, in-app notifications, other user interface features, or one or more combinations thereof.

The one or more I/O ports 2110 allow client device 2100 to be logically coupled to other devices, including the one or more I/O components 2112, some of which may be built in. Example I/O components 2112 can include a microphone, joystick, game pad, satellite dish, scanner, printer, wireless device, and the like. The one or more I/O components 2112 may, for example, provide a natural user interface that processes air gestures, voice, or other physiological inputs generated by a user. In some instances, the inputs the user generates may be transmitted to an appropriate network element for further processing. A natural user interface may implement any combination of speech recognition, touch and stylus recognition, facial recognition, biometric recognition, gesture recognition both on screen and adjacent to the screen, air gestures, head and eye tracking, and touch recognition associated with the one or more presentation components 2108 on the client device 2100.

In some embodiments, the client device 2100 may be equipped with one or more depth cameras, one or more stereoscopic cameras, one or more infrared cameras, one or more RGB cameras, another type of image generating device (e.g., for gesture detection and recognition), or one or more combinations thereof. Additionally, the client device 2100 may, additionally or alternatively, be equipped with one or more accelerometers, gyroscopes, magnetometers, cameras, capacitance sensors, proximity sensors (e.g., an infrared proximity sensor or a capacitive proximity sensor), an atmospheric pressure sensor, a gesture sensor, a grip sensor, a color sensor, an illuminance sensor, a humidity sensor, another type of sensor, or one or more combinations thereof. In some embodiments, the output of the motion or orientation sensors may be provided to the one or more presentation components 2108 of the client device 2100 to render immersive augmented reality, virtual reality, another type of extended reality, or one or more combinations thereof.

The power supply 2114 of client device 2100 may be implemented as one or more batteries or another power source for providing power to components of the client device 2100. In embodiments, the power supply 2114 can include an external power supply, such as an AC adapter or a powered docking cradle that supplements or recharges the one or more batteries. In aspects, the external power supply can override one or more batteries or another type of power source located within the client device 2100.

Some embodiments of client device 2100 may include one or more radios 2116 (or similar wireless communication components). The one or more radios 2116 can transmit, receive, or both transmit and receive signals for wireless communications. In embodiments, the client device 2100 may be a wireless terminal adapted to receive communications and media over various wireless networks. Client device 2100 may communicate using the one or more radios 2116 via one or more wireless protocols, such as code division multiple access (“CDMA”), global system for mobiles (“GSM”), time division multiple access (“TDMA”), another type of wireless protocol, or one or more combinations thereof. In embodiments, the wireless communications may include one or more short-range connections (e.g., a Wi-Fi® connection, a Bluetooth connection, a near-field communication connection), a long-range connection (e.g., CDMA, GPRS, GSM, TDMA, 802.16 protocols), or one or more combinations thereof. In some embodiments, the one or more radios 2116 may facilitate communication via radio frequency signals, frames, blocks, transmission streams, packets, messages, data items, data, another type of wireless communication, or one or more combinations thereof.

The one or more radios 2116 may be capable of transmitting, receiving, or both transmitting and receiving wireless communications via mm waves, FD-MIMO, massive MIMO, 3G, 4G, 5G, 6G, another type of Generation, 802.11 protocols and techniques, another type of wireless communication, or one or more combinations thereof.

In some embodiments of the client device for the confined individual, the correctional facility may implement particular restrictions (e.g., Wi-Fi restrictions such as particular webpages or websites, access to Wi-Fi only without access to wireless telecommunication services provided via a telecommunications provider) for one or more client devices (e.g., tablets) provided to the confined individual during particular time periods.

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software. For instance, various functions may be carried out by a processor executing instructions stored in memory. As such, other arrangements and elements (for example, machines, interfaces, functions, orders, and groupings of functions, and the like) can be used in addition to, or instead of, those shown.

Embodiments of the present disclosure have been described with the intent to be illustrative rather than restrictive. Embodiments described in the paragraphs above may be combined with one or more of the specifically described alternatives. In particular, an embodiment that is claimed may contain a reference, in the alternative, to more than one other embodiment. The embodiment that is claimed may specify a further limitation of the subject matter claimed. Alternative embodiments will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

The invention claimed is:

1. A secure communications system comprising:
one or more processors; and
computer memory storing computer-usable instructions that, when executed by the one or more processors, cause the system to perform operations comprising:
providing one or more counsel identifiers and one or more identifiers for a confined individual to a correctional system;
receiving, from the correctional system, a confirmation associated with the one or more counsel identifiers and the one or more identifiers for the confined individual;
based on receiving the confirmation, scheduling a video conference for the confined individual;
initiating the video conference between a counsel device associated with the one or more counsel identifiers and a client device associated with the one or more identifiers for the confined individual;
providing, during the video conference, an electronic document to the client device;
receiving a modification to the electronic document; and
removing access to the modified electronic document from the client device upon completion of the video conference.

2. The secure communications system according to claim 1, wherein the modification to the electronic document is received from the client device.

3. The secure communications system according to claim 1, the operations further comprising:
determining a jurisdiction associated with the confined individual for a legal proceeding involving the confined individual;
identifying electronic legal resources corresponding to the jurisdiction and the legal proceeding;
providing the electronic legal resources to a user interface of the counsel device; and
transmitting one or more of the electronic legal resources to the client device based on providing the electronic legal resources to the counsel device.

4. The secure communications system according to claim 3, wherein the one or more of the electronic legal resources are transmitted to the client device prior to the completion of the video conference.

5. The secure communications system according to claim 1, the operations further comprising:
providing a messaging thread interface to the client device and the counsel device during the video conference between the counsel device and the client device;
receiving one or more textual inputs via the messaging thread interface; and
removing access to the one or more textual inputs from the client device upon the completion of the video conference.

6. The secure communications system according to claim 1, the operations further comprising:
automatically storing an amount of time of the video conference, upon the completion of the video conference, within a data store associated with the secure communications system;
receiving a request from the correctional system for the amount of time; and
transmitting the amount of time of the video conference to the correctional system.

7. The secure communications system according to claim 1, the operations further comprising:
receiving, from the counsel device, an indication to include an interpreter for the video conference;
receiving one or more interpreter identifiers for the interpreter; and
based on the indication to include the interpreter and based on the one or more interpreter identifiers, providing a computer device associated with the one or more interpreter identifiers access to the video conference.

8. The secure communications system according to claim 1, the operations further comprising:
based on scheduling the video conference between the counsel device associated with the one or more counsel identifiers and the client device associated with the one or more identifiers for the confined individual, updating an administrative portal for the correctional system to include a date and time of the video conference, an expected duration of the video conference, and at least one of the one or more identifiers for the confined individual.

9. A method comprising:
providing one or more legal counsel identifiers and one or more identifiers for a confined individual to a correctional facility system;
receiving, from the correctional facility system, a confirmation associated with the one or more legal counsel identifiers and the one or more identifiers for the confined individual;
based on the confirmation, transmitting a request to the correctional facility system to schedule a parole interview video conference for the confined individual;
based on transmitting the request, scheduling the parole interview video conference for the confined individual; and
initiating the parole interview video conference between at least one client device corresponding to at least one parole board member and a client device corresponding to the confined individual, wherein the parole interview video conference is initiated based on the one or more identifiers for the confined individual and one or more identifiers for the at least one parole board member.

10. The method according to claim 9, further comprising:
receiving an indication to include an interpreter for the parole interview video conference;
receiving one or more interpreter identifiers for the interpreter; and
transmitting access to the parole interview video conference to a computer device associated with the one or more interpreter identifiers based on verifying the one or more interpreter identifiers.

11. The method according to claim 9, further comprising:
providing a messaging thread interface during the parole interview video conference;
receiving one or more textual inputs via the messaging thread interface; and
removing access to the one or more textual inputs from the client device corresponding to the confined individual upon completion of the parole interview video conference.

12. The method according to claim 11, wherein the one or more textual inputs is received from the client device corresponding to the confined individual.

13. The method according to claim 9, further comprising:
based on scheduling the parole interview video conference for the confined individual and prior to initiating the parole interview video conference, identifying electronic legal resources corresponding to the parole interview and an associated jurisdiction;
providing the electronic legal resources to a legal counsel device corresponding to the one or more legal counsel identifiers; and
transmitting, prior to initiating the parole interview video conference, one or more of the electronic legal resources to the client device corresponding to the confined individual based on providing the electronic legal resources to the legal counsel device.

14. One or more non-transitory computer storage media having computer-executable instructions embodied thereon, that when executed by at least one processor, cause the at least one processor to perform a method comprising:
providing one or more legal counsel identifiers and one or more identifiers for a confined individual to a correctional facility system;
receiving, from the correctional facility system, a confirmation associated with the one or more legal counsel identifiers and the one or more identifiers for the confined individual;
based on receiving the confirmation, scheduling a video conference for the confined individual; and
causing initiation of the video conference between a legal counsel device associated with the one or more legal counsel identifiers and a client device associated with the one or more identifiers for the confined individual.

15. The one or more non-transitory computer storage media of claim 14, further comprising:
causing to provide, during the video conference, an electronic legal document to the client device;
receiving a modification to the electronic legal document; and
removing access to the modified electronic legal document from the client device upon completion of the video conference.

16. The one or more non-transitory computer storage media of claim 14, further comprising:
causing to provide a messaging thread interface to the client device and the legal counsel device during the video conference between the legal counsel device and the client device;
receiving one or more textual inputs via the messaging thread interface from one or more of the client device and the legal counsel device; and
removing access to the one or more textual inputs from the client device upon completion of the video conference without removing access to the one or more textual inputs from the legal counsel device.

17. The one or more non-transitory computer storage media of claim 14, wherein the one or more identifiers for the confined individual include a digital image of the confined individual and an alphanumeric identifier.

18. The one or more non-transitory computer storage media of claim 14, further comprising automatically populating an electronic legal document of a legal proceeding corresponding to the confined individual.

19. The one or more non-transitory computer storage media of claim 14, further comprising: based on scheduling the video conference and prior to initiating the video conference, causing the transmission of a notification to the correctional facility system, the notification including a date and time of the video conference and at least one of the one or more identifiers for the confined individual.

20. The one or more non-transitory computer storage media of claim 14, wherein the video conference between the legal counsel device and the client device is initiated based on comparing facial features of the confined individual from a camera of the client device with the one or more identifiers for the confined individual including a photo identifier of the confined individual.
